(19) United States
(12) Patent Application Publication
(10) Pub. No.: US 2026/0065179 A1
(43) Pub. Date: Mar. 5, 2026

(54) AUTOMATED INFERRING OF HOURS OF OPERATION FOR WORKFORCE MANAGEMENT SKILLS

(71) Applicant: NICE LTD., Ra'anana (IL)

(72) Inventors: Vaibhav CHOBE, Pune (IN); Gurprit JOHAL, Pune (IN); Gaurav SURYAWANSHI, Pune (IN)

(21) Appl. No.: 18/818,436

(22) Filed: Aug. 28, 2024

(51) Int. Cl. G06Q 10/0631; G06Q 10/04

(52) U.S. Cl. CPC G06Q 10/063112; G06Q 10/04; G06Q 10/06315

(57) ABSTRACT

A method for automatedly determining hours of operation (HOO) is provided. A system for work allocation is also provided. A method for generating staffing forecasts is also provided. The method for automatedly determining hours of operation includes performing historical data analysis on historical data comprising past data for a plurality of skills, queue reports for the plurality of skills, or a combination thereof; identifying trends in skills demand for each of the plurality of skills based on the historical data analysis; performing analysis on forecasted reports for skills allocation to generate future demand patterns for each of the plurality of skills; performing HOO analysis for each of the plurality of skills based on the generated future demand patterns and identified skills demand trends; generating a report of the HOO analysis for the plurality of skills; and providing the analysis report to a user.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to a system and a method for work force management, for example, for automatedly determining hours of operation, generating staffing forecasts, or work allocation.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized (or be conventional or well-known) in the prior art. The subject matter in the background section merely represents different approaches, which in and of themselves may also be inventions.

Staffing forecasts are pivotal in ensuring smooth operations within any organization. The current method of entering the hour of operations (HOO) for workforce management (WFM) skills manually by WFM Managers/Supervisors, however, poses significant challenges. This traditional approach not only introduces the potential for errors but also generally neglects to account for holidays, thereby compromising the accuracy of staffing calculations.

The HOO for WFM skills plays a central role in the efficient allocation of workforce resources. The reliance on manual data entry for assigning HOO within WFM solutions exacerbates the risk of inaccuracies. This outdated practice fails to consider various holiday scenarios, thereby undermining the reliability of staffing forecasts. Moreover, it places undue burden on WFM Managers/Supervisors, who must meticulously input this information, leaving room for entry errors, interpretation errors, and other inconsistencies. The repercussions of inaccuracies in HOO assignment may be profound. Suboptimal resource allocation can result in overstaffing or understaffing, leading to operational inefficiencies and compromised service quality. Ultimately, this can manifest in dissatisfied customers, increased costs, and diminished overall performance metrics. Furthermore, the manual nature of this process consumes valuable time and resources that could otherwise be allocated to strategic initiatives or proactive problem-solving.

Thus, there is a need for streamlining the process of determining HOO for WFM skills, for example, to leverage historical data analysis and forecasted reports to accurately calculate HOO for each WFM skill, thus reducing reliance on manual intervention and enhancing operational efficiency.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 depicts a block diagram illustrating a simplified view of a system for work allocation, in accordance with various embodiments.

FIG. 2A depicts a block diagram illustrating a hardware architecture for an example workforce management system, such as the system illustrated in FIG. 1, in accordance with various embodiments.

FIG. 2B depicts a block diagram illustrating a software architecture for an example workforce management system, such as the system illustrated in FIG. 1, in accordance with various embodiments.

FIG. 3 depicts a block diagram illustrating a skill hours of operation (HOO) generation system, in accordance with various embodiments.

FIG. 4 depicts a block diagram illustrating a process for a high-level skill HOO generation flow, in accordance with various embodiments.

FIG. 5 depicts a block diagram illustrating a process for filtering and capturing slot wise volume metrics per skill, in accordance with various embodiments.

FIG. 6 depicts a block diagram illustrating a process for calculating HOO per skill, in accordance with various embodiments.

FIG. 7 depicts a block diagram illustrating a process for staffing generation using skill HOO, in accordance with various embodiments.

FIG. 8 depicts a user interface for performing workforce management skills, in accordance with various embodiments.

FIG. 9 depicts a user interface displaying forecasted outcomes, in accordance with various embodiments.

FIG. 10 is a block diagram of a computer system for work allocation, in accordance with various embodiments.

FIG. 11 is a flow chart for a method for automatedly determining hours of operation (HOO), in accordance with various embodiments.

FIG. 12 is a flow chart for a method for generating staffing forecasts, in accordance with various embodiments.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

In accordance with various embodiments disclosed herein, a system for work allocation is provided. In one or more embodiments, the disclosed system may be an automated system that can be implemented to streamline the process of determining hours of operation for workforce management skills. The disclosed system may leverage historical data analysis and forecasted reports to accurately calculate hours of operation for each workforce management skill, thereby reducing reliance on manual intervention and enhancing operational efficiency. As such, the disclosed system may employ a method for automatedly determining hours of operation by analyzing historical data and forecasted reports.

The disclosed system (and methods, etc.) may be implemented to perform a comprehensive analysis of historical skill/queue generated forecasted reports for each workforce management skill. By scrutinizing past data, the disclosed system may be used to identify trends in demand for various workforce management skills over different time periods. This analysis, in turn, may enable the disclosed system to discern patterns of usage and anticipate fluctuations in demand, laying the foundation for precise hours of operation calculations.

In one or more embodiments, the disclosed system may be configured to perform analysis of forecasted reports to predict future demand patterns for each workforce management skill. By extrapolating from historical trends and incorporating factors such as market dynamics and business projections, the disclosed system may be implemented to generate forecasts that offer a forward-looking perspective on demand fluctuations. This proactive approach may empower various users, e.g., organizations to adapt their hours of operation strategies in anticipation of changing demand scenarios, thereby minimizing the risk of understaffing or overstaffing, in accordance with one or more embodiments. In various embodiments, the disclosed system may include a configuration, or a module configured to be able to provide the flexibility while calculating the hours of operation. In one or more embodiments, such system configuration may be provided by the user/supervisor at the time of forecast generation, which may be used further in the hours of operation calculation.

In one or more embodiments, the disclosed system may be configured, based on the insights from the input historical data analysis and forecasted report analysis, to undertake the computation of hours of operation for each workforce management skill. In one or more embodiments, the disclosed system may consider factors, such as for example, but not limited to, peak demand periods, seasonal variations, and specific holidays (e.g., which may vary by office or agent location or any other factor), and optionally even planned leave. Using such factors, the disclosed system may be implemented to generate hours of operation schedules that align closely with anticipated demand levels, in accordance with one or more embodiments disclosed herein. Such granular approach to hours of operation calculation may ensure optimal resource allocation, thereby enhancing operational efficiency and service delivery standards.

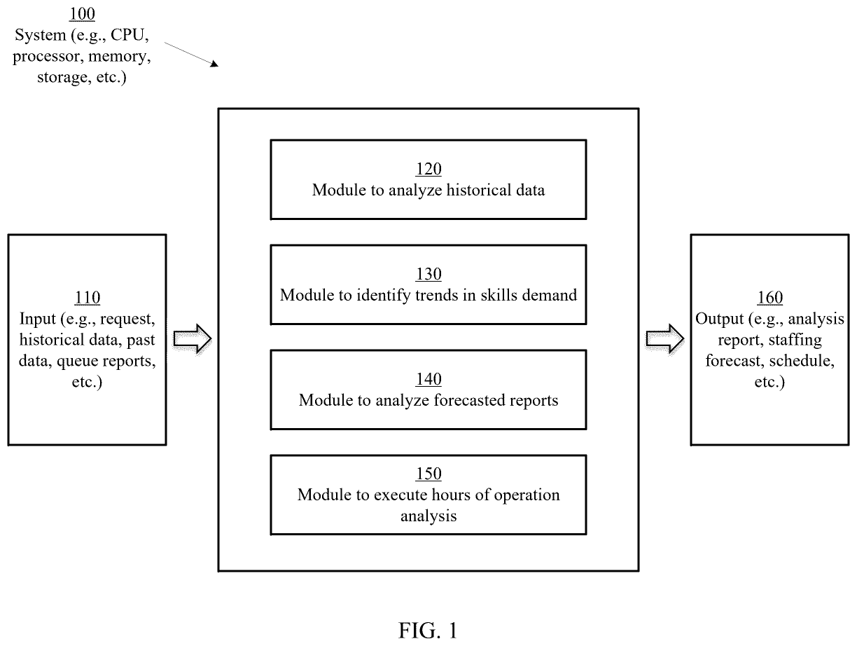

In one or more embodiments, the disclosed system may be implemented to execute a method for generating staffing forecasts. The disclosed method may include, among others, a method for determining the hours of operation. The disclosed method may include performing historical data analysis on historical data comprising past data for a plurality of skills, queue reports for the plurality of skills, or a combination thereof; identifying trends in skills demand for each of the plurality of skills based on the historical data analysis; performing analysis on forecasted reports for skills allocation to generate future demand patterns for each of the plurality of skills; performing the hours of operation analysis for each of the plurality of skills based on the generated future demand patterns and identified skills demand trends; generating a report of the hours of operation analysis for the plurality of skills; and providing the analysis report to a user. The disclosed system and methods are further described with respect to FIGS. 1-12, in accordance with various embodiments.

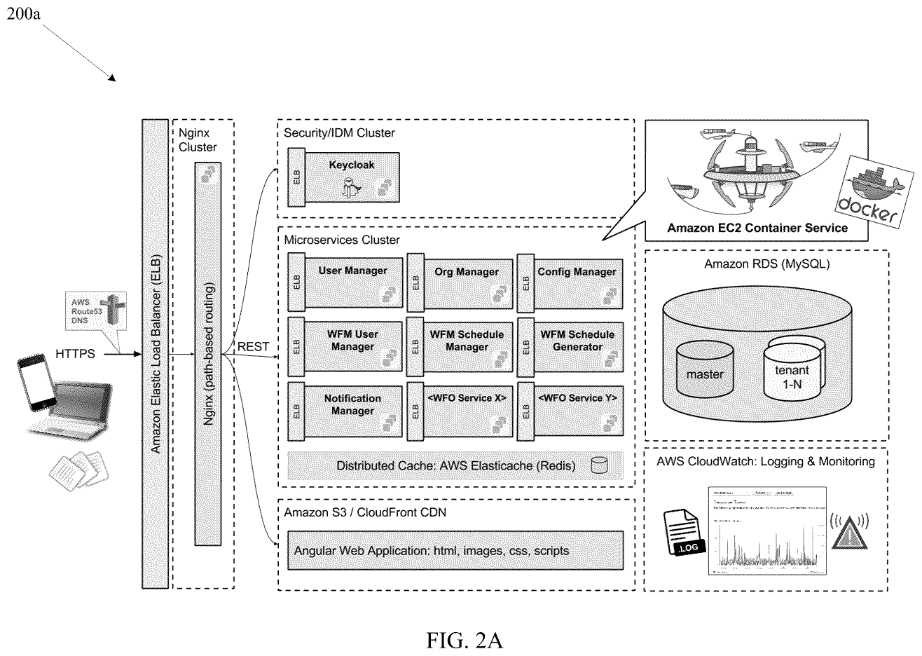

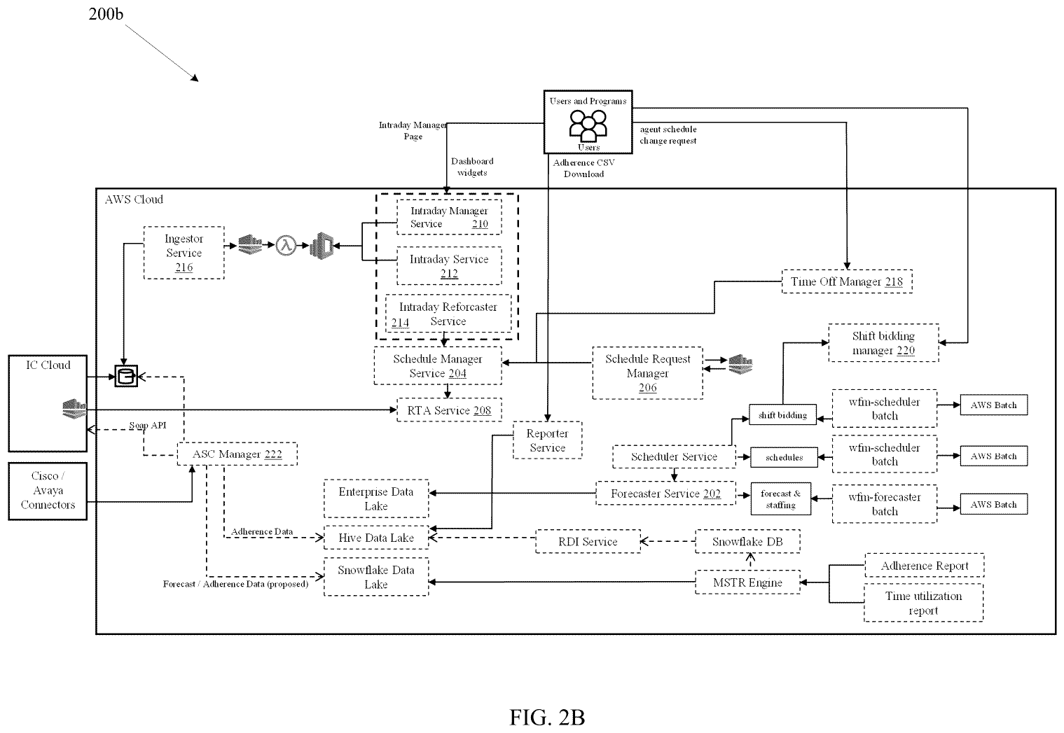

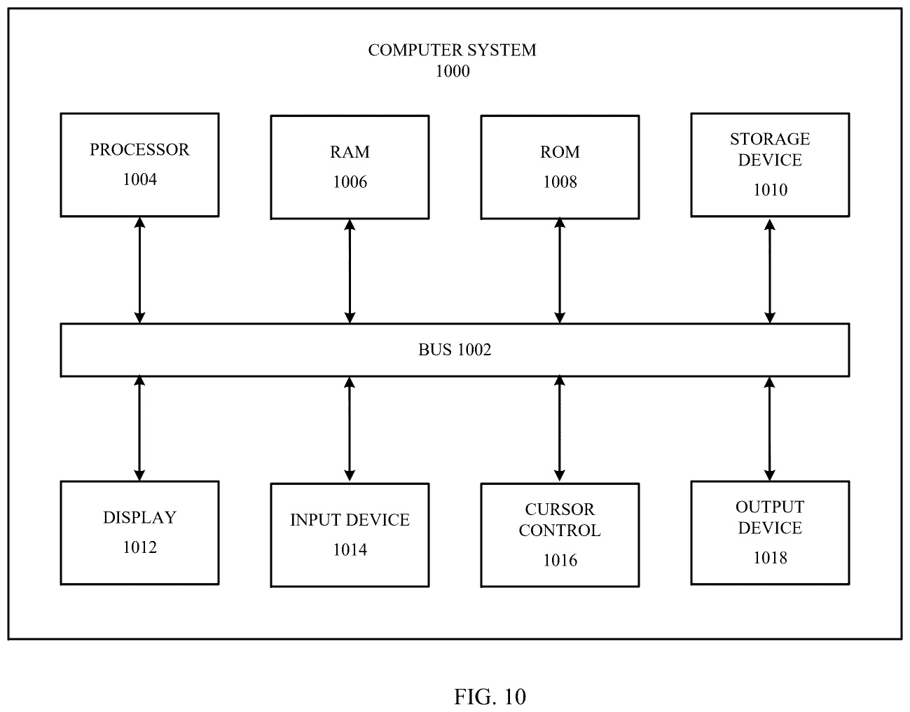

FIG. 1 depicts a block diagram illustrating a simplified view of a system 100 for work allocation, in accordance with various embodiments. As illustrated in FIG. 1, the system 100 may include a computer system, such as computer system 1000 as described below with respect to FIG. 10, having one or more processors, CPUs, storage, and a non-transitory computer readable medium, e.g., a memory, operably coupled to the processor(s). The computer system/processor may be configured to execute instructions stored on the memory/non-transitory computer readable medium. The instructions may include a set of instructions to perform various work allocation operations. These operations, as further illustrated in various blocks of FIG. 1, may include, but not limited to, receiving at block 110, an input, such as for example, but not limited to, a request, historical data, past data, queue reports, etc., performing various operations at blocks 120, 130, 140, and 150, via various modules, and outputting at block 160, an output, such as for example, but not limited to, an analysis report, staffing forecast, schedule of various work functions, etc. The various operations that are performed at blocks 120, 130, 140, and 150, where each block include a module to configured to perform one or more specific functions. For example, block 120 includes a module to analyze historical data comprising past data and queue reports for a plurality of skills, whereas block 130 includes a module to identify trends in skills demand for each of the plurality of skills based on the analyzed historical data, block 140 includes a module to analyze forecasted reports for skills allocation to generate future demand patterns for each of the plurality of skills, and block 150 includes a module to execute hours of operation analysis for each of the plurality of skills based on the generated future demand patterns and identified skills demand trends. The resulting output generated at block 160 may include, for example, a staffing forecast for work allocation based on the hours of operation analysis. Various modules and components of the system 100, i.e., blocks, of FIG. 1 are described in further detail with respect to FIGS. 2-12.

The system 100 as described with respect to FIG. 1 may be implemented to perform, for example, workforce management skill hours of operation. When setting up the workforce management skill hours of operation, in one or more embodiments, the system 100 may be configured to gather data from the past and checks it against what's happening now, and then use it to perform additional tasks to ensure the correct hours of operation for each specific skill in the workforce management system. In such cases, the system 100 may be configured to automatically adjust the schedules so that each skill has the right coverage based on how busy it's been historically and currently. The workforce management system may include the following sub-components.

### Workforce Management System

FIG. 2A depicts a block diagram illustrating a hardware architecture 200a for an example workforce management system, such as the system 100 illustrated in FIG. 1, in accordance with various embodiments. FIG. 2B depicts a block diagram illustrating a software architecture 200b for the workforce management system, such as the system 100 illustrated in FIG. 1, in accordance with various embodiments. As depicted in FIGS. 2A and 2B, the system 100 may further include the following modules and components.

### Forecaster Service 202

The forecaster service may be used to help predict how many calls a business might get in the future and how long it will take to handle them. Its functions may include:
1. Using Past Data: It looks at the records of how many calls came in before, such as over a pre-selected time period or by one or more agents, and how long the calls took to handle. Then, it uses this information to guess how many calls there might be and how long it will take to deal with them in the future.
2. Making Plans: Based on these guesses, it helps make plans for how many staff members are needed to handle the anticipated number of calls efficiently. This way, businesses can make sure they have enough people to help customers without making them wait too long.
3. Showing Information: It also creates helpful charts and graphs to show the past data, the predictions for the future, and the plans for staffing. This facilitates business understanding of anticipated needs so it can more efficiently make plans accordingly.
4. Customizing Forecasts: It allows users to create, edit, and view different types of prediction profiles. This means businesses can adjust the predictions based on different factors or changes in their operations.
5. Importing Plans: It can take in staffing plans from other sources, making it easier for businesses to integrate their existing systems with the Forecaster Service.
6. Handling Special Days: If there are special days where the number of calls might be different, like holidays or big sales events, the Forecaster Service can take that into account if this feature is enabled.

### Schedule Manager 204

The schedule manager may be configured such that it behaves as if it is in charge of scheduling at a company. Its functions may include:
1. Storing and Retrieving Data: It keeps track of all the work schedule information, like who's working when and for how long. It also manages how many people are needed for each shift based on anticipated agent capacity and call demand.
2. Setting Up Schedules: It holds all the rules and settings needed to create schedules. This includes things like what happens every day and every week, and can use special codes for different activities.
3. Handling Shift Trades: If employees want to swap shifts with each other, the Schedule Manager 204 takes care of that too. It keeps track of who's working which shift and makes sure agent availability stays balanced with workload demand.

In one or more embodiments, the Schedule Manager 204 may be configured to behave as the brain of the scheduling system, keeping everything organized and running smoothly.

### Schedule Requests Manager 206

The Schedule Requests Manager (SRM) is like the control center for handling all the requests agents make about their schedules. Its functions are listed as follows:
1. Managing Requests: SRM is responsible for dealing with any requests agents have about their schedules. It handles everything from adding and editing requests to approving or declining them. However, it doesn't completely delete requests; it just marks them as canceled, which can permit further review and adjustment based on revised parameters or forecasts.
2. Validation: When a new request is made or an existing one is edited, SRM checks it against the rules using another tool called the Schedule Rules Automation MS Validate API. If the request goes against any automatic approval rules, it won't be submitted. For instance, if there's a rule that automatically declines certain types of requests, SRM won't let them through for further consideration.
3. Coordinating with Schedule Manager: SRM works closely with the Schedule Manager 204. When a request is approved, SRM tells the Schedule Manager to update the schedule accordingly.
4. Notifications: This provides notifications to relevant personnel. For example, managers are notified when requests are made, and agents are informed if their requests are approved or declined.
5. Data Storage: All the information about these requests is stored in an RDS, which is like a big storage space for data, further discussed herein.

In one or more embodiments, SRM makes sure that everyone's schedule requests are handled properly and that everyone involved is informed of current activity.

### Rta Service 208

The RTA Service, or Real-Time Adherence Service, is configured to behave as a watchdog for keeping track of whether employees are sticking to their schedules. Its functions may include:
1. Comparing Activities: It looks at what employees are actually doing, which it receives, e.g., from an ACD (Automatic Call Distribution device or module). Then, it checks this against what each agent is supposed to be doing according to their schedule, which it can receive from the Schedule Manager 204.
2. Adherence Status: Based on this comparison, the RTA Service decides if an employee is following their schedule (in adherence) or not (out of adherence), and can make recommendations to a manager, send a reminder or alert to an agent or manager, etc.

### Intraday Manager Service 210

The Intraday Manager Service may be configured as a dashboard that gives managers a real-time view of how things are going during the day in a contact center. Its functions may include:
1. Showing Metrics: It displays all kinds of important data about what's happening moment by moment in a contact center. This includes things like how many calls are coming in (actual), how many were expected to come in (forecasted), and the difference between the two (variance), e.g., over a pre-selected time period such as an hour, a work shift, a day, etc.
2. Understanding Staffing Levels: By comparing the expected number of calls with the actual number, the service helps managers determine if they have enough staff to handle the workload (not understaffed) or if they have too many staff for the workload (overstaffed).

### Intraday Service 212

The Intraday Service is a part of the workforce management application. It focuses on providing data and metrics for what's happening in real-time throughout the day. The term “real-time” is intended to encompass within about 15 seconds, preferably within a few seconds. In a preferred embodiment, the term means no more than a second or even less than 0.5 seconds. The IntraDay Service functions may include:
1. Intraday Data: It collects and manages all the information about what's happening currently in the selected workforce, e.g., at a specific contact center, or for a specific product or service team. This could include information such as how many calls are coming in, how long they're taking to handle, and how many staff members are currently working.
2. Dashboard Metrics: It's responsible for feeding this real-time data into the dashboard of the WFM application. This means that managers and supervisors can see up-to-date information about what's happening with the workforce at any given moment.

### Intraday Re-Forecaster Service 214

The Intraday Re-Forecaster Service's functions may include:
1. Getting Forecast Data: It checks in with the schedule manager 204 to get information about things like how many calls are expected, how long they'll take to handle, and how many staff members are needed. Then, it saves this data into a storage space called ES.
2. Calculating Reforecast Data: Next, this service calculates if the initial forecast needs adjusting. It does this for all the areas where the reforecast feature is turned on for recalculation. Once it's done, it saves these updated predictions into the same storage space.

Both the initial forecast and the reforecast data are then used by the Intraday Manager to keep everyone updated on what's happening throughout the day.

### Ingestor Service 216

The Ingestor Service may be configured to collect data, thereby gathering information from different sources and preparing it for use. Its functions may include:
1. Collecting Data: It fetches information from an IC ACD, which tracks things like call metrics and agent skills. It then organizes this data into a format that's easier and more efficient to work with.
2. Processing Data: Instead of collecting data directly from IC ACD, it instead reads files stored in a special storage space called S3. These files contain reports and data, such as from an IC ACD, to more efficiently process the collected data and manipulate it to make forecasts and as otherwise described herein.
3. Support for Cisco UCCX ACD: Additionally, the Ingestor Service is equipped to handle data from another system called Cisco UCCX ACD. This analyzes specific areas where this data is stored and can facilitate or handle the same organizing process.

### Time-off Manager Service 218

The Time-Off Manager Service may be configured as a digital assistant for managing time off requests. Its functions may include:
1. Setting Rules: It helps managers define the rules for taking time off. This can include parameters such as how much time off employees are allowed in a given time period or at a certain point in the year, and when they can take it.
2. Calculating Balance: This keeps track of how much time off employees have used and how much they have left. This helps both managers and employees know where they stand.
3. Automatic Approval: It provides a way for time off requests to be automatically approved based on certain criteria. This makes the process smoother and faster for everyone involved.

### Shift Bidding Manager Service 220

The Shift Bidding Manager Service may be configured as a referee for managing who gets to work when. Its functions may include:
1. Managing Bids: This handles the process of employees bidding on specific shifts. Employees can choose which shifts they prefer to work, and the service helps manage who gets assigned to each shift.
2. Defining Schedules: This allows supervisors to create different work schedules and open them up for bidding by employees. This gives employees more control over their work hours.
3. Assigning Shifts: Based on the bids submitted by employees, the service assigns shifts to employees according to their preferences and ranking.

### ASC Manager 222

The ASC Manager may be configured to work as a bridge between different parts of the workforce management system. Its functions may include:
1. Integrating Systems: Connects the workforce management system with ACD systems to enable the exchange of essential data. This allows for the exchange of important data.
2. Handling Data: Deals with various types of data, including historical call data and real-time agent adherence data.
3. User Interface: This provides a user interface, typically a GUI, for importing and cleaning historical data, making it easier for users to work with the data effectively.

### Skill Hours of Operation (HOO) Generation for Contact Center Supervisor

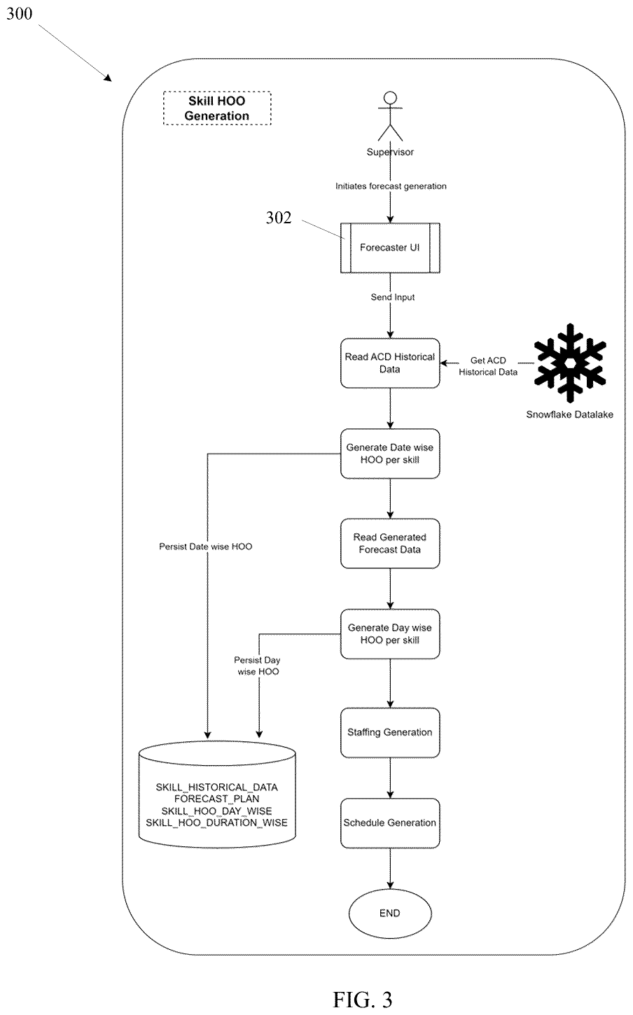

FIG. 3 depicts a block diagram illustrating a skill hours of operation (HOO) generation system 300, in accordance with various embodiments. The Skill HOO generation system 300 may include a Forecaster UI WebApp, a backend Forecaster Microservice (MS), and databases, such as, for example, but not limited to Snowflake™ for historical data and RDS for processed data. The user interacts with the Forecaster UI 302 to initiate Skill HOO generation, which involves several steps handled by the Forecaster MS.

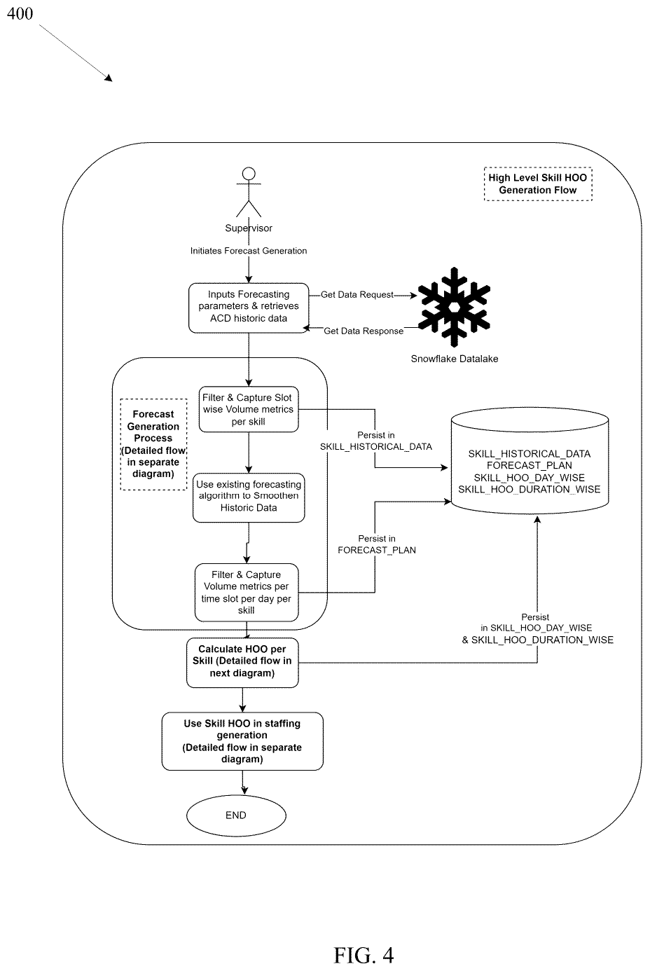

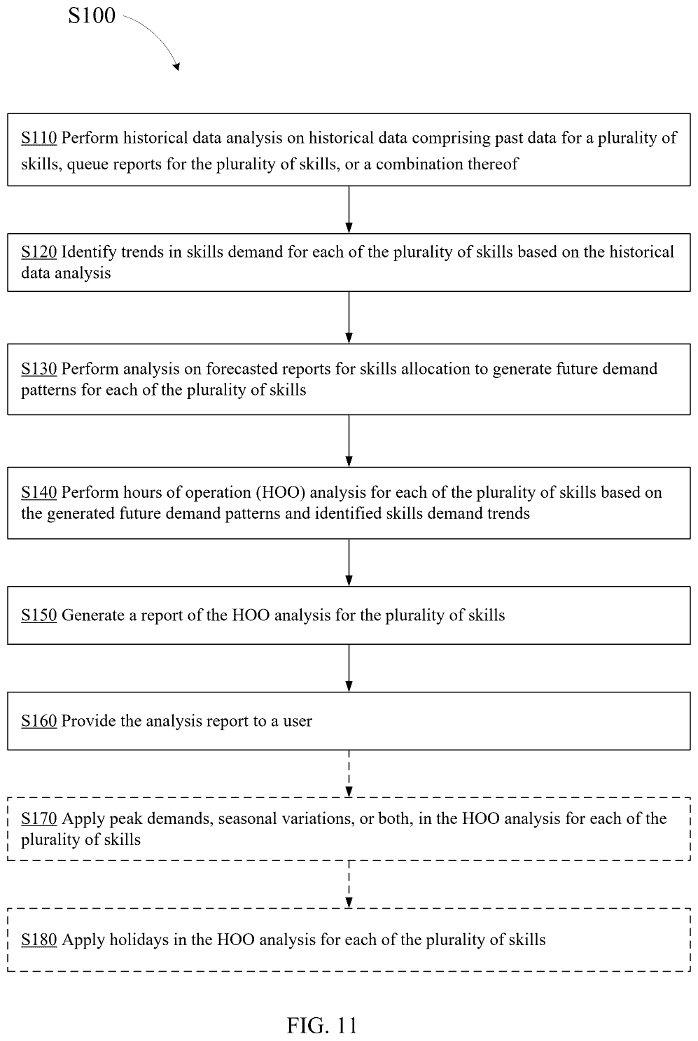

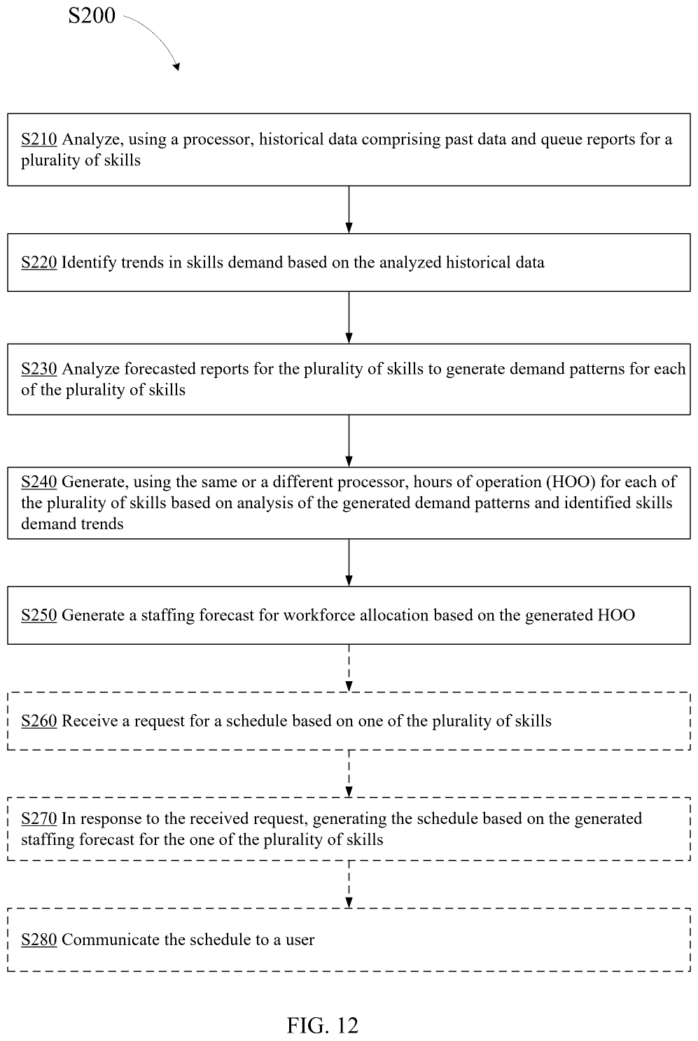

FIG. 4 depicts a block diagram illustrating a process 400 for a high-level skill HOO generation flow, in accordance with various embodiments. The process 400 can be further described with respect to methods S100 and S200 as described with respect to FIGS. 11 and 12 below.

### Component Description

1. Forecaster UI WebApp: A web interface for the contact center supervisor to initiate Skill HOO generation and view results.
2. Forecaster Microservice (MS): A backend service responsible for retrieving, processing, and storing data.
3. Snowflake™: A cloud data warehouse for storing historical ACD data, used as an exemplary option herein. Any available cloud data warehouse may be used.
4. RDS Database: A relational database service storing processed data, including Skill HOO results.

### Detailed Design Embodiments

### Forecaster UI WebApp

User Interface: A form for the supervisor to input parameters required for Skill HOO generation (e.g., date range, skills).
API Integration: Calls the Forecaster MS API to initiate the Skill HOO generation process.
Error Handling: Displays appropriate error messages if the Skill HOO generation fails.

### Skill HOO Generation Process

Data Retrieval: Connects to Snowflake™ to fetch historical ACD data based on user inputs.
Data Storage: Stores retrieved data in the RDS database for further processing.
Data Processing: Applies suitable smoothing algorithms to the data and calculates Skill HOO.
Result Storage: Saves the Skill HOO results back in the RDS database.

### Data Flow Example

1. User inputs parameters and initiates Skill HOO generation via the UI.
2. The Forecaster UI sends the input data to the Forecaster MS API.
3. The Forecaster MS retrieves historical data from Snowflake.
4. The retrieved data is stored in the RDS database.
5. The Forecaster MS processes the data to smooth it and calculate Skill HOO.
6. The Skill HOO results are stored in the RDS database.
7. Staffing generation uses Skill HOO and generates the staffing.
8. Schedule generation uses generated staffing to generate schedules for the agents considering demand per skill.

### Database Design Example

### Snowflake™ Schema

Table: ACD_Historical_Data
   ‘date’
   ‘skill’
   ‘call_volume’
   ‘other_relevant_metrics’

### RDS Schema

Table: Retrieved_Data
   ‘id’
   ‘date’
   ‘skill’
   ‘call_volume’
   ‘other_relevant_metrics’
Table: Skill_HOO
   ‘id’
   ‘skill’
   ‘start_time’
   ‘end_time’
   ‘date’

### API Specifications

### Endpoint: Initiate Forecast Generation

URL: ‘/api/forecast’
Method: POST
Request Body:
   ‘startDate’: Date
   ‘endDate’: Date
   ‘skills’: Array of skill identifiers
Response:
   ‘status’: success/failure
   ‘message’: Details of the operation

### Detailed Workflow & Algorithm Description Embodiments

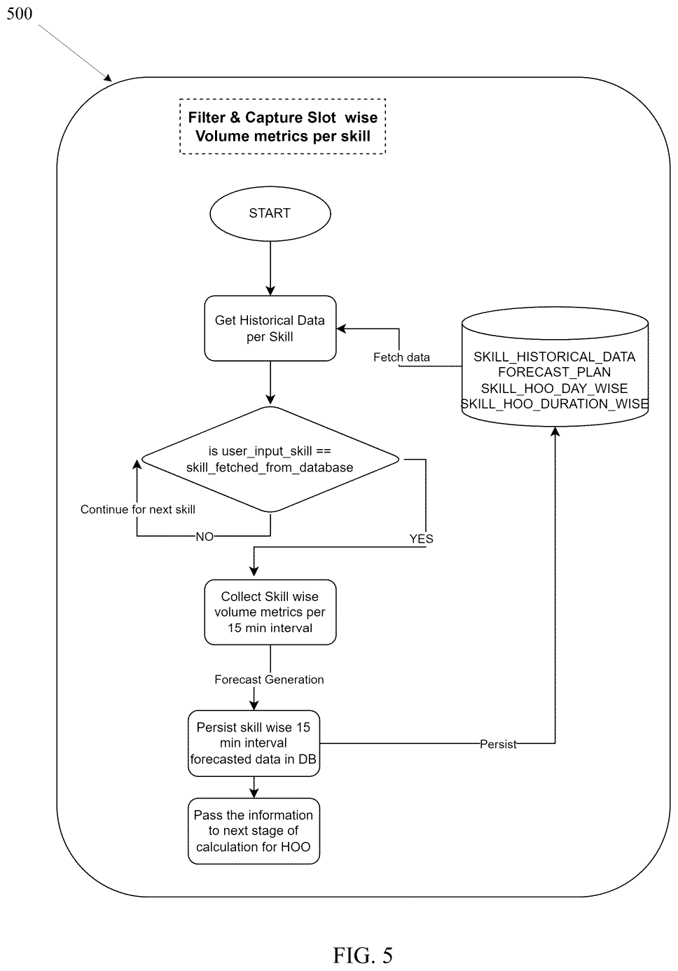

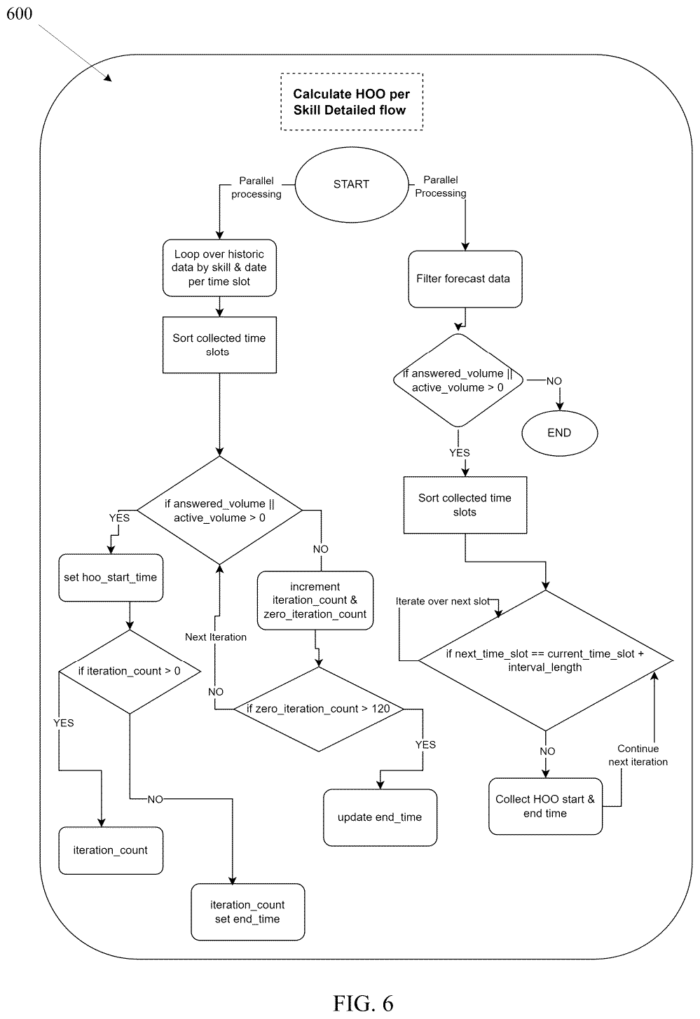

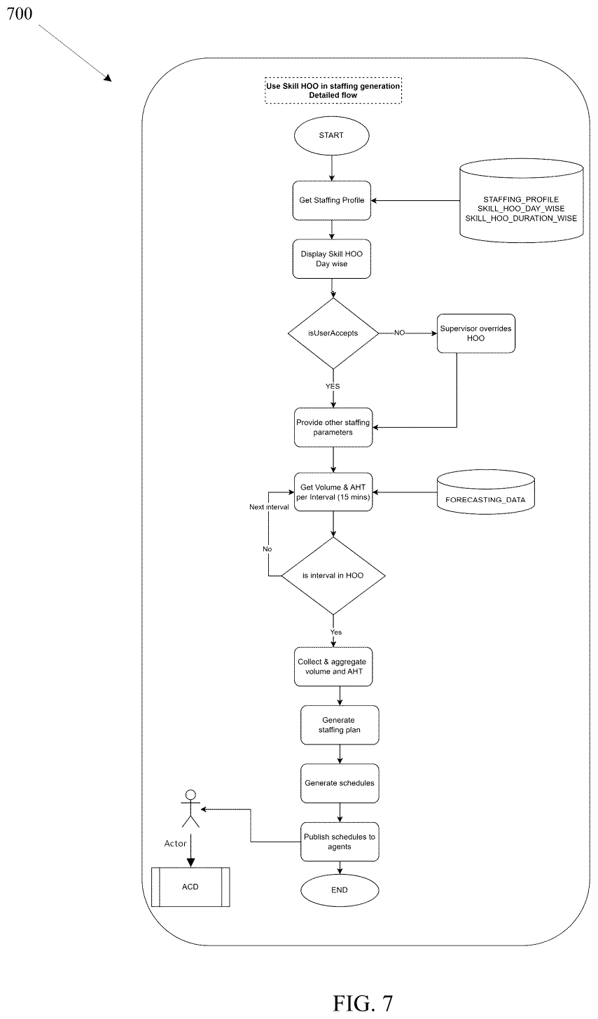

FIG. 5 depicts a block diagram illustrating a process 500 for filtering and capturing slot wise volume metrics per skill, in accordance with various embodiments. FIG. 6 depicts a block diagram illustrating a process 600 for calculating HOO per skill, in accordance with various embodiments. FIG. 7 depicts a block diagram illustrating a process 700 for staffing generation using skill HOO, in accordance with various embodiments. Detailed discussions of the processes 600, 700, and 800 are as follows and are further described with respect to methods S100 and S200 as described with respect to FIGS. 11 and 12.

### HOO Calculation Date Wise Algorithm

The following includes a step-by-step algorithm as an example for performing Hour of Operation (HOO) analysis on historical data to derive date-wise HOO:
1. Input: Historical records containing interval data with start time, end time, and active call volume.
2. Initialize variables:
   zero_volume_counter=0
   start_time=null
   end_time=null
   configured_threshold (set by user)
3. Sort the interval data based on historical data.
4. Iterate over all intervals in the historical records:
   a. For each interval:
      Check if the start time is null and the active call volume is greater than 0:
         If yes, set the start time to the current interval and move to the next interval.
         If no:
         Check if the start time is not null and the volume is greater than 0:
         If yes, set the end time to the current interval and move to the next interval.
         If no:
         Check if the start is null and volume is less than or equal to 0:
         If yes, move to the next interval.
         If no:
         Check if the volume is less than or equal to 0:
         If yes:
         Increment the zero_volume_counter.
         Check if zero_volume_counter is less than the configured_threshold:
         If yes, collect the start and end times of the hour of operation. After collecting, reset the start and end times.
         If no, move to the next iteration.

This algorithm iterates through all intervals in the historical records, identifying periods of activity based on the configured threshold for zero volume intervals. It collects the start and end times of these operational hours for further analysis.

### HOO Calculation Day Wise Algorithm

The following includes a step-by-step algorithm example for performing Hours of Operation (HOO) analysis on forecasted result to derive day-wise HOO:
1. Input: Forecasted records containing interval data with start time, end time, and active call volume.
2. Initialize variables:
   zero_volume_counter=0
   start_time=null
   end_time=null
   configured_threshold (set by user)
3. Sort the interval data based on forecasted data.
4. Iterate over all intervals in the forecasted records:
a. For each interval:
   Check if the start time is null and the active call volume is greater than 0:
      If yes, set the start time to the current interval and move to the next interval.
      If no:
         Check if the start time is not null and the volume is greater than 0:
         If yes, set the end time to the current interval and move to the next interval.
         If no:
         Check if the start is null and volume is less than or equal to 0:
         If yes, move to the next interval.
         If no:
         Check if the volume is less than or equal to 0:
         If yes:
         Increment the zero_volume_counter.
         Check if zero_volume_counter is less than the configured_threshold:
         If yes, collect the start and end times of the hour of operation. After collecting, reset the start and end times.
         If No, Move to the Next Iteration.

This algorithm iterates through all intervals in the forecasted records, identifying periods of activity based on the configured threshold for zero volume intervals. It collects the start and end times of these operational hours for further analysis.

### Use of Derived Skill HOO in Staffing & Scheduling Algorithm Example

1. Start: The process begins with the initiation of the staffing generation.
2. Get Staffing Profile:
   The system retrieves the staffing profile, which includes user input parameters like shrinkage, Service Level, ASA etc.
3. Display Skill's HOO Day Wise:
   The system displays the Skill Hours Of Operation (HOO) data, broken down by day. This data shows the hours during which different skills are needed.
4. User Acceptance Check:
   Decision Point: isUserAccepts
      The system checks if the user (supervisor) accepts the displayed Skill HOO.
      If Yes: The user accepts the displayed Skill HOO, and the process proceeds to the next step.
      If No: The user does not accept the displayed Skill HOO, and the process allows the supervisor to override the HOO.
5. Supervisor Overrides HOO:
   If the user does not accept the displayed Skill HOO, the supervisor can manually override the HOO data. This step involves updating the HOO to reflect the supervisor's input.
6. Provide Other Staffing Parameters:
   The user provides additional parameters required for staffing generation, such as agent availability, skill levels, and other relevant details.
7. Get Volume & AHT per Interval (15 mins):
   The system retrieves forecasting data, specifically the call volume and Average Handle Time (AHT) for each 15-minute interval.
8. Interval in HOO Check:
   Decision Point: is interval in HOO
      The system checks if the current interval is within the defined HOO.
      If Yes: The interval is within HOO, and the system proceeds to the next step.
      If No: The interval is not within HOO, and the system moves to the next interval.
9. Collect & Aggregate Volume and AHT:
   For intervals within the HOO, the system collects and aggregates the call volume and AHT data. This aggregation is necessary to determine the staffing requirements.
10. Generate Staffing Plan:
   Using the aggregated data, the system generates a staffing plan. This plan outlines the number of agents needed per interval, considering the call volume, AHT, and other provided parameters.
11. Generate Schedules:
   Based on the staffing plan, the system generates detailed schedules for the agents. These schedules specify when each agent should be on duty to meet the forecasted demand.
12. Publish Schedules to Agents:
   The generated schedules are published to the agents. This step involves notifying the agents of their upcoming shifts and making the schedules available through the appropriate channels (e.g., an internal portal or email).
13. End: The process concludes with the schedules being available to the agents.

### Threshold Definition

Any period without calls lasting less than 2 hours (120 minutes), e.g., may still be counted as operational time. This means even if there are no calls for a short period, it is considered part of the working hours.

### Input Data

For a specific date, showing call volume for each 15-minute interval:
From midnight to 1:00 AM: No calls (Duration=60 minutes)
From 1:15 AM to 4:45 AM: Calls received
From 5:00 AM to 8:00 AM: No calls (Duration=180 minutes)
From 8:15 AM to 1:45 PM: Calls received
And so on, with data continuing for the rest of the day.

### Calculation Process Example

1. Initiation: The calculation process starts at midnight.
2. Interval Analysis: Analysis proceeds with each interval one by one, checking if there were any calls.
3. Zero Volume Intervals: Looking at the interval from midnight to 1:00 AM, there were no calls during this time, resulting in a duration of 60 minutes with zero volume.
4. Threshold Comparison: Since this duration is less than our threshold of 120 minutes, it is considered as part of the operational hours.
5. Threshold Exceedance: However, from 5:00 AM to 8:00 AM, there were no calls for a duration of 180 minutes, which exceeds our threshold. Therefore, the operational hours are marked as from midnight to 4:45 AM for this period.
6. Continuation: This process is continued for each interval, identifying operational hours as we go.
7. Recording: Once identified, these operational hour durations recorded as HOO.

### HOO for a Day

For example, on Monday: Operational hours are determined from midnight to 4:45 AM and from 8:15 AM to 1:45 PM.

### HOO for a Date

This process is repeated for each day within the specified date range.

### Multiple HOOs in a Single Day or Date

If there are multiple instances of operational hours within a single day or date, each instance is treated as a separate HOO duration. This means if there are two periods of no calls separated by calls in between, each of these periods may be counted separately as operational hours.

### User Interface

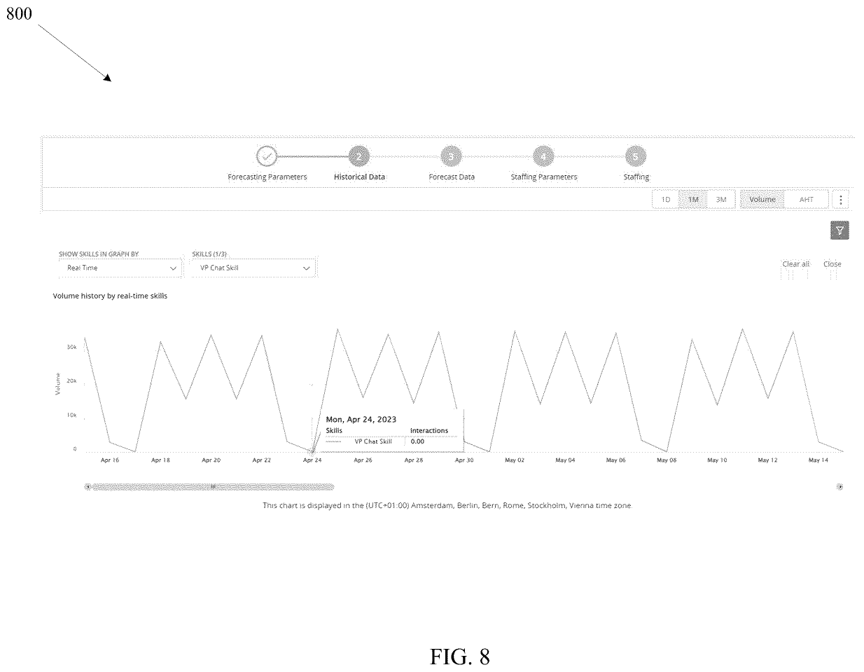

FIG. 8 depicts a user interface 800 for performing workforce management skills, in accordance with various embodiments. As shown in FIG. 8, the user interface 800 offers a comprehensive look into the historical data of WFM Skills. These skills encompass data that's been aggregated from all the underlying ACD-Skill sources. Once the WFM Skill data are gathered and consolidated, simultaneous calculations may be performed for the HOO, employing specific aggregation methods.

Throughout this calculation process, the data may be analyzed on a daily basis, or even more frequently, such as a shift-basis, if helpful. This approach provides a clear and accurate picture of any alterations in the HOO over a designated timeframe in the past. By showcasing this trend, users can effortlessly pinpoint and grasp any shifts in operational hours over time for each WFM Skill.

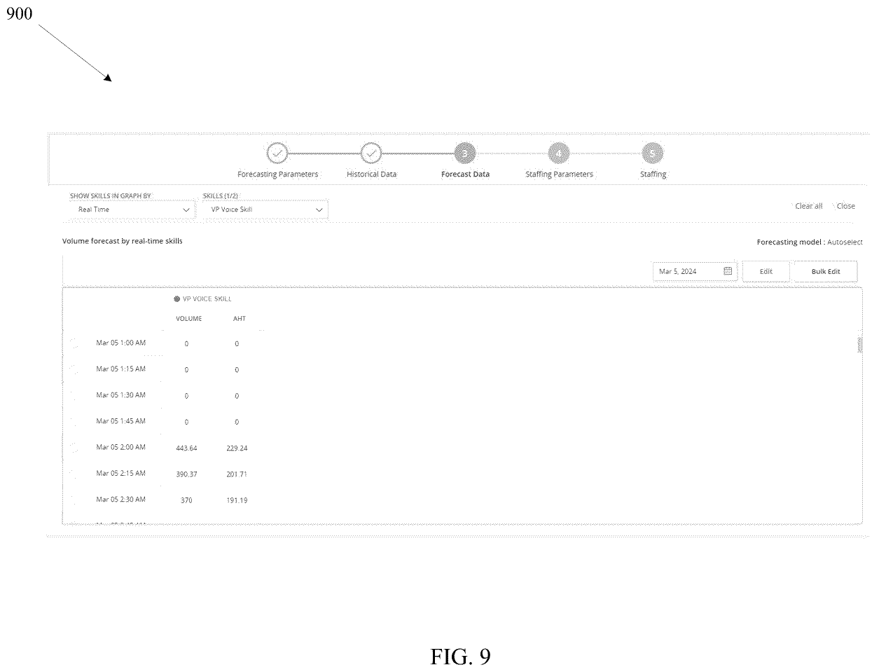

FIG. 9 depicts a user interface 900 displaying forecasted outcomes, in accordance with various embodiments. As shown in FIG. 9, this specific segment within the user interface 900 displays the forecasted outcomes for each selected WFM Skill designated for forecasting. After generating the forecasted results, an algorithm is executed aimed at calculating the Hours-of-Operation on a daily basis.

Given that the forecasted result data developed according to the disclosure is already smoothed out using any suitable data smoothing algorithm, effectively eliminating outliers, the calculation of Hours-of-Operation becomes significantly more precise compared to our previous calculations based solely on historical data and date-wise analysis. This enhanced precision ensures a more accurate representation of operational hours, allowing for better-informed decision-making.

FIG. 10 is a block diagram of a computer system 1000 for work allocation, in accordance with various embodiments. The computer system 1000 may be an example of one implementation for various systems, such as the disclosed system 100, or various processes described with respect to FIGS. 1-9, and methods, such as methods S100 and S200 as described below with respect to FIGS. 11 and 12.

In one or more examples, computer system 1000 can include a bus 1002 or other communication mechanism for communicating information, and a processor 1004 coupled with bus 1002 for processing information. In various embodiments, computer system 1000 can also include a memory, which can be a random-access memory (RAM) 1006 or other dynamic storage device, coupled to bus 1002 for determining instructions to be executed by processor 1004. Memory also can be used for storing temporary variables or other intermediate information during execution of instructions to be executed by processor 1004. In various embodiments, computer system 1000 can further include a read only memory (ROM) 1008 or other static storage device coupled to bus 1002 for storing static information and instructions for processor 1004. A storage device 1010, such as a magnetic disk or optical disk, can be provided and coupled to bus 1002 for storing information and instructions.

In various embodiments, computer system 1000 can be coupled via bus 1002 to a display 1012, such as a cathode ray tube (CRT), liquid crystal display (LCD), or light emitting diode (LED) for displaying information to a computer user. An input device 1014, including alphanumeric and other keys, can be coupled to bus 1002 for communicating information and command selections to processor 1004. Another type of user input device is a cursor control 1016, such as a mouse, a joystick, a trackball, a gesture input device, a gaze-based input device, or cursor direction keys, for communicating direction information and command selections to processor 1004 and for controlling cursor movement on display 1012. This input device 1014 typically has two degrees of freedom in two axes, a first axis (e.g., x) and a second axis (e.g., y), that allows the device to specify positions in a plane. However, it should be understood that input devices 1014 allowing for three-dimensional (e.g., x, y, and z) cursor movement are also contemplated herein.

Consistent with certain implementations of the present teachings, results can be provided by computer system 1000 in response to processor 1004 executing one or more sequences of one or more instructions contained in RAM 1006. Such instructions can be read into RAM 1006 from another computer-readable medium or computer-readable storage medium, such as storage device 1010. Execution of the sequences of instructions contained in RAM 1006 can cause processor 1004 to perform the processes described herein. Alternatively, hard-wired circuitry can be used in place of or in combination with software instructions to implement the present teachings. Thus, implementations of the present teachings are not limited to any specific combination of hardware circuitry and software.

The term “computer-readable medium” (e.g., data store, data storage, storage device, data storage device, etc.) or “computer-readable storage medium” as used herein refers to any media that participates in providing instructions to processor 1004 for execution. Such a medium can take many forms, including but not limited to, non-volatile or non-transitory media, volatile media, and transmission media. Examples of non-volatile media can include, but are not limited to, optical, solid state, magnetic disks, such as storage device 1010. Examples of volatile media can include, but are not limited to, dynamic memory, such as RAM 1006. Examples of transmission media can include, but are not limited to, coaxial cables, copper wire, and fiber optics, including the wires that comprise bus 1002.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, or any other tangible medium from which a computer can read.

In addition to computer readable medium, instructions or data can be provided as signals on transmission media included in a communications apparatus or system to provide sequences of one or more instructions to processor 1004 of computer system 1000 for execution. For example, a communication apparatus may include a transceiver having signals indicative of instructions and data. The instructions and data are configured to cause one or more processors to implement the functions outlined in the disclosure herein. Representative examples of data communications transmission connections can include, but are not limited to, telephone modem connections, wide area networks (WAN), local area networks (LAN), infrared data connections, NFC connections, optical communications connections, etc.

It should be appreciated that the methodologies described herein, flow charts, diagrams, and accompanying disclosure can be implemented using computer system 1000 as a standalone device or on a distributed network of shared computer processing resources such as a cloud computing network.

The methodologies described herein may be implemented by various means depending upon the application. For example, these methodologies may be implemented in hardware, firmware, software, or any combination thereof. For a hardware implementation, the processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

In various embodiments, the methods of the present teachings may be implemented as firmware and/or a software program and applications written in conventional programming languages such as C, C++, Python, etc. If implemented as firmware and/or software, the embodiments described herein can be implemented on a non-transitory computer-readable medium in which a program is stored for causing a computer to perform the methods described above. It should be understood that the various engines described herein can be provided on a computer system, such as computer system 1000, whereby processor 1004 would execute the analyses and determinations provided by these engines, subject to instructions provided by any one of, or a combination of, the memory components RAM 1006, ROM, 1008, or storage device 1010 and user input provided via input device 1014.

FIG. 11 is a flow chart for method S100 for automatedly determining hours of operation (HOO), in accordance with various embodiments. As illustrated in FIG. 11, the method S100 includes, at step S110, performing historical data analysis on historical data comprising past data for a plurality of skills, queue reports for the plurality of skills, or a combination thereof; at step S120, identifying trends in skills demand for each of the plurality of skills based on the historical data analysis; at step S130, performing analysis on forecasted reports for skills allocation to generate future demand patterns for each of the plurality of skills; at step S140, performing HOO analysis for each of the plurality of skills based on the generated future demand patterns and identified skills demand trends; at step S150, generating a report of the HOO analysis for the plurality of skills; and at step S160, providing the analysis report to a user.

As further illustrated in FIG. 11, the method S100 optionally includes, at step S170, applying peak demands, seasonal variations, or both, in the HOO analysis for each of the plurality of skills. Furthermore, the method S100 optionally includes, at step S180, applying holidays in the HOO analysis for each of the plurality of skills.

In one or more embodiments, the HOO analysis may be performed to generate date-wise HOO for each of the plurality of skills using the historical data. In one or more embodiments, the HOO analysis may be performed to generate day-wise HOO for each of the plurality of skills using the forecasted reports

In one or more embodiments, the HOO analysis for each of the plurality of skills may further include the following: collecting, for each of the plurality of skills, volume metrics for a pre-determined time interval; applying the collected volume metrics for each of the plurality of skills to persistently generate the volume metrics on a skill-by-skill basis; and storing the volume metrics for each of the plurality of skills in a database.

As further illustrated in FIG. 11, the method S100 optionally includes receiving a request for a schedule based on one of the plurality of skills; and in response to the received request, generating the schedule based on the report of the HOO analysis for the one of the plurality of skills, wherein the user is a contact center agent or a supervisor for a contact center. In one or more embodiments, the schedule may include a day-wise HOO and/or a duration-wise HOO for each of the plurality of skills.

In various embodiments, a system for work allocation may utilize the method S100 as described with respect to FIG. 11. In accordance with one or more embodiments, a system for work allocation is provided. The system includes one or more processors and a non-transitory computer readable medium operably coupled thereto, the non-transitory computer readable medium comprising a plurality of instructions stored in association therewith that are accessible to, and executable by, the one or more processors, to perform work allocation operations. The work allocation operations performed by the system may include analyzing historical data comprising past data and queue reports for a plurality of skills; identifying trends in skills demand for each of the plurality of skills based on the analyzed historical data; analyzing forecasted reports for skills allocation to generate future demand patterns for each of the plurality of skills; executing hours of operation (HOO) analysis for each of the plurality of skills based on the generated future demand patterns and identified skills demand trends; and generating a staffing forecast for work allocation based on the HOO analysis.

In one or more embodiments of the AI-based fraud detection system, the work allocation operations may further include applying peak demands, seasonal variations, or both, for the plurality of skills in the HOO analysis for each of the plurality of skills; and/or applying holidays in the HOO analysis for each of the plurality of skills.

In one or more embodiments, executing the HOO analysis for each of the plurality of skills may include: collecting, for each of the plurality of skills, volume metrics for a pre-determined time interval; applying the collected volume metrics to persistently generate the volume metrics; and storing the volume metrics for each of the plurality of skills in a database.

In one or more embodiments, the work allocation operations may further include: receiving a request for a schedule based on one of the plurality of skills; in response to the received request, generating the schedule based on the report of the HOO analysis for the one of the plurality of skills; and providing the schedule to a contact center agent or a supervisor for a contact center. In one or more embodiments, the skill wise schedule includes a day-wise HOO and/or a duration-wise HOO for each of the plurality of skills.

FIG. 12 is a flow chart for a method S200 for generating staffing forecasts, in accordance with various embodiments. The method S200 may include additional or complementary processing steps, a computer, or a processor, compared to those of the method S100, in one or more embodiments. As shown in FIG. 12, the method S200 includes, at step S210, analyzing, using a processor, historical data comprising past data and queue reports for a plurality of skills; at step S220, identifying trends in skills demand based on the analyzed historical data; at step S230, analyzing forecasted reports for the plurality of skills to generate demand patterns for each of the plurality of skills; at step S240, generating, using the same or a different processor, hours of operation (HOO) for each of the plurality of skills based on analysis of the generated demand patterns and identified skills demand trends; and at step S250, generating a staffing forecast for workforce allocation based on the generated HOO.

As further illustrated in FIG. 12, the method S200 optionally includes, at step S260, receiving a request for a schedule based on one of the plurality of skills; at step S270, in response to the received request, generating the schedule based on the generated staffing forecast for the one of the plurality of skills; and at step S280, communicating the schedule to a user.

In one or more embodiments of the method S200, generating the HOO for each of the plurality of skills further comprises applying peak demands, seasonal variations, or both, to the analysis of the generated demand patterns and identified skills demand trends. In one or more embodiments, generating the HOO for each of the plurality of skills further comprises applying holidays to the analysis of the generated demand patterns and identified skills demand trends. In one or more embodiments, generating the HOO for each of the plurality of skills further comprises generating date-wise HOO based on the analyzed historical data. In one or more embodiments, generating the HOO for each of the plurality of skills further comprises generating day-wise HOO based on the analyzed forecasted reports.

In one or more embodiments, generating the HOO for each of the plurality of skills may further include: collecting, for each of the plurality of skills, volume metrics for a pre-determined time interval; applying the collected volume metrics for each of the plurality of skills to persistently generate the volume metrics on a skill-by-skill basis; and storing the volume metrics for each of the plurality of skills in a database.

In various embodiments, a system for generating staffing forecasts may utilize the method S200 for generating staffing forecasts as described with respect to FIG. 12.

What is claimed is:

1. A method for automatedly determining hours of operation (HOO), which comprises:
performing historical data analysis on historical data comprising past data for a plurality of skills, queue reports for the plurality of skills, or a combination thereof;
identifying trends in skills demand for each of the plurality of skills based on the historical data analysis;
performing analysis on forecasted reports for skills allocation to generate future demand patterns for each of the plurality of skills;
performing HOO analysis for each of the plurality of skills based on the generated future demand patterns and identified skills demand trends;
generating a report of the HOO analysis for the plurality of skills; and
providing the analysis report to a user.

2. The method of claim 1, further comprising:
applying peak demands, seasonal variations, or both, in the HOO analysis for each of the plurality of skills.

3. The method of claim 1, further comprising:
applying holidays in the HOO analysis for each of the plurality of skills.

4. The method of claim 1, wherein the HOO analysis is performed to generate date-wise HOO for each of the plurality of skills using the historical data.

5. The method of claim 1, wherein the HOO analysis is performed to generate day-wise HOO for each of the plurality of skills using the forecasted reports.

6. The method of claim 1, wherein the HOO analysis for each of the plurality of skills comprises:
collecting, for each of the plurality of skills, volume metrics for a pre-determined time interval;
applying the collected volume metrics for each of the plurality of skills to persistently generate the volume metrics on a skill-by-skill basis; and
storing the volume metrics for each of the plurality of skills in a database.

7. The method of claim 1, further comprising:
receiving a request for a schedule based on one of the plurality of skills; and
in response to the received request, generating the schedule based on the report of the HOO analysis for the one of the plurality of skills, wherein the user is a contact center agent or a supervisor for a contact center.

8. The method of claim 7, wherein the schedule comprises a day-wise HOO and/or a duration-wise HOO for each of the plurality of skills.

9. A system for work allocation comprising one or more processors and a non-transitory computer readable medium operably coupled thereto, the non-transitory computer readable medium comprising a plurality of instructions stored in association therewith that are accessible to, and executable by, the one or more processors, to perform work allocation operations which comprise:
analyzing historical data comprising past data and queue reports for a plurality of skills;
identifying trends in skills demand for each of the plurality of skills based on the analyzed historical data;
analyzing forecasted reports for skills allocation to generate future demand patterns for each of the plurality of skills;
executing hours of operation (HOO) analysis for each of the plurality of skills based on the generated future demand patterns and identified skills demand trends; and
generating a staffing forecast for work allocation based on the HOO analysis.

10. The system of claim 9, wherein the work allocation operations further comprise:
applying peak demands, seasonal variations, or both, for the plurality of skills in the HOO analysis for each of the plurality of skills; and/or
applying holidays in the HOO analysis for each of the plurality of skills.

11. The system of claim 9, wherein executing the HOO analysis for each of the plurality of skills comprises:
collecting, for each of the plurality of skills, volume metrics for a pre-determined time interval;
applying the collected volume metrics to persistently generate the volume metrics; and
storing the volume metrics for each of the plurality of skills in a database.

12. The system of claim 9, wherein the work allocation operations further comprise:
receiving a request for a schedule based on one of the plurality of skills;
in response to the received request, generating the schedule based on the report of the HOO analysis for the one of the plurality of skills; and
providing the schedule to a contact center agent or a supervisor for a contact center.

13. The system of claim 12, wherein the skill wise schedule comprises a day-wise HOO and/or a duration-wise HOO for each of the plurality of skills.

14. A method for generating staffing forecasts comprising:
analyzing, using a processor, historical data comprising past data and queue reports for a plurality of skills;
identifying trends in skills demand based on the analyzed historical data;
analyzing forecasted reports for the plurality of skills to generate demand patterns for each of the plurality of skills;
generating, using the same or a different processor, hours of operation (HOO) for each of the plurality of skills based on analysis of the generated demand patterns and identified skills demand trends; and
generating a staffing forecast for workforce allocation based on the generated HOO.

15. The method of claim 14, further comprising:
receiving a request for a schedule based on one of the plurality of skills;
in response to the received request, generating the schedule based on the generated staffing forecast for the one of the plurality of skills; and
communicating the schedule to a user.

16. The method of claim 14, wherein generating the HOO for each of the plurality of skills further comprises applying peak demands, seasonal variations, or both, to the analysis of the generated demand patterns and identified skills demand trends.

17. The method of claim 14, wherein generating the HOO for each of the plurality of skills further comprises applying holidays to the analysis of the generated demand patterns and identified skills demand trends.

18. The method of claim 14, wherein generating the HOO for each of the plurality of skills further comprises generating date-wise HOO based on the analyzed historical data.

19. The method of claim 14, wherein generating the HOO for each of the plurality of skills further comprises generating day-wise HOO based on the analyzed forecasted reports.

20. The method of claim 14, wherein generating the HOO for each of the plurality of skills further comprises:
collecting, for each of the plurality of skills, volume metrics for a pre-determined time interval;
applying the collected volume metrics for each of the plurality of skills to persistently generate the volume metrics on a skill-by-skill basis; and
storing the volume metrics for each of the plurality of skills in a database.
